(19) United States
(12) Patent Application Publication
(10) Pub. No.: US 2008/0216255 A1
(43) Pub. Date: Sep. 11, 2008

(54) Textile Marker Application Method and Textiles Produced therefrom

(76) Inventors: Robert Lee Poovey, Gastonia, NC (US); William Matthew Poovey, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/067,102

(22) PCT Filed: Sep. 15, 2006
(86) PCT No.: PCT/US06/36198

§ 371 Date: Mar. 17, 2008

Related U.S. Application Data
(60) Provisional application No. 60/596,341, filed on Sep. 17, 2005.

(51) Int. Cl. D02G 3/44; D02G 3/00; D03D 15/00; C09B 62/00

(52) U.S. Cl. 8/543; 428/372; 442/187

(57) ABSTRACT

A textile marker application process includes the steps of contacting a fibrous material with an application liquor containing a marker. The composition of the liquor and the process conditions are selected to produce a uniform distribution of the marker within the fibrous material. The marked textile may be used alone or incorporated in a textile or non-textile product for identification.

### BACKGROUND OF THE INVENTION

This invention relates generally to identification markers and more particularly to the application of markers to textiles.

Various types of “markers” or “taggants” have been developed including chemicals, dyes, nucleic acid based products, radioisotopes, magnetic particles, and the like. These markers share the common property that they are very small (e.g. powders, particles, or molecules) or otherwise not readily detectible on cursory examination, but can be detected after they are applied to an object by appropriate detection equipment, or by laboratory testing.

There is an increasing interest in applying these markers to textile products for security, brand identification, product tracking, authentication, supply chain logistics, etc. However, to be of use in textile products, these markers must be uniformly applied to threads, yarns, or fibers.

### BRIEF SUMMARY OF THE INVENTION

Accordingly, it is an object of the invention to provide a method of uniformly applying markers to textile materials.

It is another object of the invention to provide a textile product having a marker distributed uniformly therein.

These and other objects are met by the present invention, which according to one aspect provides a marked textile fiber assembly including a textile fiber assembly having at least one identifiable marker disposed therein, the marker being distributed substantially uniformly throughout the fiber assembly.

According to another aspect of the invention, the marker has an identifying property that is substantially indetectible in normal use.

According to another aspect of the invention, the marker is nucleic acid based.

According to another aspect of the invention, the amount of marker disposed in the textile fiber assembly is less than 1 part per billion to about 10,000 parts per million.

According to another aspect of the invention, the amount of marker disposed in the textile fiber assembly is less than 1 part per billion to about 1000 parts per million.

According to another aspect of the invention, the marker has an average size of less than 1 nanometer to about 20 microns.

According to another aspect of the invention, the marker has an average size of less than 1 nanometer to about 10 microns.

According to another aspect of the invention, a woven label includes a marked textile fiber assembly having at least one identifiable marker disposed therein, the marker being distributed substantially uniformly throughout the fiber assembly.

According to another aspect of the invention, a garment includes a marked textile fiber assembly including a textile fiber assembly having at least one identifiable marker disposed therein, the marker being distributed substantially uniformly throughout the fiber assembly.

According to another aspect of the invention, a sewing thread includes a marked textile fiber assembly including a textile fiber assembly having at least one identifiable marker disposed therein, the marker being distributed substantially uniformly throughout the fiber.

According to another aspect of the invention, a method of producing a marked textile fiber assembly includes: providing a textile fiber assembly; and contacting the fiber assembly with a fluid including a marker under preselected conditions such that the marker is distributed substantially uniformly throughout the fiber assembly.

According to another aspect of the invention, the marker has an identifying property that is substantially indetectible in normal use.

According to another aspect of the invention, the fluid is water-based.

According to another aspect of the invention, the fluid further includes a chemical selected from the group consisting of silicone emulsions, mixtures of siloxanes and silicones, and mixtures thereof.

According to another aspect of the invention, the quantity of chemical applied is about 0.1% to about 30%, by weight of textile fiber.

According to another aspect of the invention, the quantity of chemical applied is about 0.25% to about 10%, by weight of textile fiber.

According to another aspect of the invention, the quantity of chemical applied is about 0.25% and about 8%, by weight of textile fiber.

According to another aspect of the invention, the fluid further contains a phosphate buffer.

### DETAILED DESCRIPTION OF THE INVENTION

As used herein, the terms “marker” or “taggant” will be used interchangeably. These terms refer to any substance which can be applied to a textile product and which be detected in the finished product by appropriate detection equipment, or by laboratory testing. Markers can include chemical products, dyes, nucleic acid based products, radioisotopes, magnetic particles and the like. Typically, suitable markers are supplied as very fine powders, particles, dispersions, suspension concentrates, pastes, other liquids, or other suitable forms.

The markers can be applied to any textile product. Non-limiting examples of textile products include fiber assemblies such as yarn, sewing thread, sliver or roving, labels for garments or other products, other fibrous materials, and garments. Textile products marked using the present invention can be embedded, attached, or otherwise included with non-textile products to perform an effective marking function. Textile fiber assemblies marked as described herein can also be used independently as markers, integrated into products as markers, or used as raw materials in the manufacture of marked products.

Fibers that can be treated include polyester, nylon, acrylic, aramid, polypropylene, olefin and other manufactured fibers, as well as cotton, rayon, and other cellulose based fibers, wool and other protein fibers and other natural fibers. Materials that can be treated using the method described herein include both spun and filament forms.

In the method described herein markers are applied using processes in which the application fluid is pumped either through stationary material (such as in a package dyeing machine, beam dyeing machine, etc) or in processes in which either the material and/or the application fluid is moving (such as some package dyeing machines, hank dyeing machines, skein dyeing machines, etc).

Markers can also be successfully applied using processes and methods that transfer the marker and chemistry onto the sewing thread as the sewing thread or other fiber assembly passes by or through an application device. Typically these processes include chemical baths or applicators that are held stationary while the sewing thread or yarn is moved through or adjacent to the application device.

Typically the chemical and marker system is mixed or stirred before and or during the application process. Uniform transfer of chemistry and marker from the application process onto the yarn is an important element in this application process. Selection of chemistry is also important to achieve uniform marker distribution along the length of the sewing thread as well as to achieve specific end-use performance properties such as resistance to washing, rubbing, UV and other forms of electromagnetic degradation, frictional forces (fiber-to-fiber, fiber-to-metal, etc.), and other end-use conditions encountered during the manufacture or use of yarns, sewing thread, sewn products, or label affixed to products. Chemistries are selected based on their dispersing properties, emulsification properties, lubricating properties, film forming properties, cross-linking properties, and compatibility properties.

In a first embodiment, yarns, threads or other fibrous materials are treated using processes and equipment similar to that used for a known package dyeing for textile coloration.

Apparatus for the application process includes several major components including a kier, a package carrier, and a pump. The kier is a large open vessel into which a carrier loaded with packages is placed. The carrier is a platform that has hollow perforated metal spindles sticking vertically out of a base.

The kier is attached to a series of pipes, valves, and drains, all of which are connected to a pump. The pump pushes liquids through the package under high pressure, enabling the liquids to uniformly penetrate the all parts of the package. The pump is monitored and controlled by an automated microprocessor or computerized control system of a known type. The automated control system monitors the conditions inside of the kier, including temperature, flow rates, cycle times, chemical add times, reversal rates, and the like. The apparatus may also include provisions for flow reversal (i.e. outside-in to inside-out relative to the packages), and incremental chemical addition to the kier.

Initially, the yarn, sewing thread, or other fibrous material is wound onto a perforated tube of a known type referred to as a “dye tube”. Once the material has been wound onto the dye tube the entire assembly is referred to as a “package”.

The dye tubes can be rigid or compressible. The method of yarn construction generally determines the type of dye tube onto which the yarn, sewing thread, etc. is wound. Spun yarns are most commonly put on a rigid tube for the package dyeing process and textured yarns are most commonly put on a compressible dye spring.

A key element in the initial phase of the process (before the package is put in the machine) is the issue of package density. The package must not be very dense nor very soft and porous. This is a very important factor because the density of the package has a direct correlation to the amount of even liquid flow rates the entire package will receive during the dyeing process.

Once the packages are prepared, they are placed into the kier on the spindles. The holes in the spindles and the dye tubes allow for chemical and water mixtures to be pumped through the packages. Seals are provided between the packages to ensure that the liquids that are being pumped through the spindle and the package do not escape and bypass the desired flow path which is through the package. Typically the top of the kier is closed during processing, but some machines can be operated without an enclosed top.

The control system is preprogrammed to run a specific procedure unique to individual applications, yarn types, and chemical additives.

The fluid dynamics, the chemistry and the application parameters influence the uniformity of the marker on the material that is being treated. To achieve uniform application of the marker the fluid is pumped through the package using flows and flow reversals as appropriate for the type of fiber, yarn structure and density of the package that is being treated. Flows of about 1.0 gallon/lb to about 10.0 gallons/lb of material being treated are preferable with flows of about 2.0 gallons/lb to about 6.0 gallons/lb being more preferable; however, other flow rates could be used if other application parameters are controlled.

Flow of the fluid can be either in a single direction or can be reversed during the process. Chemistries are selected based on their dispersing properties, emulsification properties, lubricating properties, film forming properties, cross-linking properties, and compatibility properties. Chemicals can also be used to pretreat the sewing thread, yarns and other material prior to application of the marker to enhance the performance properties of the marker in end uses encountered by products made from textile materials, sewn products or the labels used for marking of products.

Chemistries are applied from about 0.1% to about 30%, more preferably between about 0.25% and about 10% and even more preferably between about 0.25% and about 8% based on the weight of the sewing thread or yarn that is being treated.

The amount of marker that is applied varies depending on the type of marker but typically ranges from less than 1 ppb to 10,000 ppm and even more preferably between 1 ppb and 1,000 ppm. The marker sizes are generally about 1 nanometer to about 10 micrometers in size and more specifically about 100 nanometer to about 5 micrometers in size.

Superior uniformity can be achieved when the chemistry and marker are metered into the process during the application procedure used to apply the markers to many materials. Precise metering of the chemistry and marker into the system reduces the dependence on other process control parameters. Metering rates are dependant on the overall amount of chemical to be added and the amount of material being treated with the marker.

Metering rates of about 1 ml/minute to as much as about 5 gallons/minute can be used depending on the size of the machine and the amount of material being treated: Other process control parameters can also be used to enhance the uniformity of marker distribution on the material.

Parameters such as temperature and pH can also be used to enhance the uniformity of the marker application and will vary depending on the specific application chemistry that is utilized and the fiber type that is being treated (i.e. polyester, cotton, nylon, acrylic, polypropylene, aramid fibers, wool, etc.).

### EXAMPLE 1

A package of 630 denier multifilament yarns was placed within an enclosed application machine into which an application liquor was delivered. The application liquor consisted of the following components: about 7.0% (by weight of yarn) of Champion TCI-044 silicone emulsion, available from Champion Thread Company, Gastonia, N.C. 28054 USA, a marker identified as marker A1, about 2.0% phosphate based buffer, and the balance water. After the application bath was delivered into the machine the pump was activated at a differential pressure of about 15 psi and the temperature was raised to about 71° C. (160° F.). The pump remained activated for about 80 minutes. The treated packages were then dried and tested for the presence of Champion TCI-044 and for the presence of marker A1. Various locations throughout the package were chosen for testing to ensure uniformity. The test results are shown in Table 2. All of the test results indicated positive for presence of the marker proving that a uniform distribution of the applied marker had been achieved.

TABLE 1

| Location | % TCI-044 | Marker |
|---|---|---|
| Outside | 2.43% | Positive |
| Middle | 2.48% | Positive |
| Middle | 2.80% | Positive |
| Inside | 1.78% | Positive |

In another embodiment, yarns, threads or other fibrous materials are treated using equipment and procedures similar to a known textile known textile process which uses a “kiss roll” or “winding” apparatus which is typically used for adding lubricants, flame retardants and the like to yarns or threads.

In this apparatus, a package that is ready for winding sits on an apparatus called a creel. Once the yarn is pulled off of the package it is fed through a feeder guide that controls the balloon of the yarn as it is pulled through at very high speeds. After the yarn is pulled through the feeder guide, it is fed through an adjustable spring loaded mechanism designed keep a constant tension on the yarn through the remaining winding process, known as a tension gate. If the tension is too high it will result in a very hard, or dense, package that is not acceptable. If the tension is too low the package will be very soft and this is not acceptable as well. Depending on yarn, suitable winding tension ranges are from about 40 grams to about 400 grams.

After the yarn passes through the tension gate it is guided to a roller system. which is designed to put chemicals onto the yarn. The roller is partly submerged in a desired chemical and turns under constant speed through this chemical. The chemical sticks to the roller by surface tension and other chemical properties. As the roller is submerged it picks a small amount of chemical. The roller continues turning and the yarn is brought into contact with the roller surface, where it picks up a significant portion of the chemical that is on the surface of the roller and continues through the winding process. Different yarns will pick up different amount of chemicals depending on the yarn construction, chemical type, and roller speed.

The final process in winding is the take up. The take up refers to the point in the process after the yarn has been introduced to the chemical and is ready to be put on a finished goods package. The take up is the power that pulls the yarn through all the above processes. There are two main types of take ups, drum driven and spindle driven. The entire apparatus may is monitored and controlled by an automated microprocessor or computerized control system of a known type.

### EXAMPLE 2

A single 0.45 kg (1 lb.) package of 150 denier multifilament yarn was placed in position for winding onto a finished goods package. The linear thread path of the yarn was positioned to pass over the surface of a kiss-roll applicator. The kiss roll was immersed in a mixture of siloxanes and silicones identified as Champion TCK-017 available from Champion Thread Company, and a marker. The kiss roll applicator was rotating at a rate of about 6.5 rpm with linear speed of the yarn being about 206 m/minute (225 yards/minute). The entire content of yarn on the package was processed through the application system over about 132 minutes under constant tension and speed. The distribution of finish on the yarn was tested along with a determination of the presence of marker. Positive identification of the marker was achieved for all samples as shown in Table 2. No discoloration or any noticeable properties of the yarn were changed due to the addition of the marker.

TABLE 2

| Location | % TCK-017 | Marker |
|---|---|---|
| Outside | 6.60% | Positive |
| Middle | 5.90% | Positive |
| Inside | 5.90% | Positive |

Once the yarns, threads, or other fiber assemblies have been treated using the method described above, they carry a uniformly distributed marker and can be easily authenticated depending on the different properties of the chosen marker. These yarns or threads can then be incorporated into products using any known-textile production process. Complete products such as garments may be made in whole or in part from the treated yarns or threads. Alternatively, product labels or tags may be woven from the treated yarns or thread and then applied to garments or other goods, or even to the packaging thereof.

The resulting product has desirable secure authentication characteristics. Although all types of markers may be applied, the treatment method is especially useful with nucleic acid based security markers. These types of markers are capable of storing complex codes that are invisible in normal use, easily identifiable through testing, and very difficult and time consuming to replicate. Accordingly, they are highly useful for brand identification, tracking of the movement of goods through a supply chain and other similar applications. Such marked products are especially useful in combating the proliferation of “knock-off” or counterfeit goods, because the expense and difficulty in replicating the secure markers will often be prohibitive to low-cost copying operations.

The foregoing has described a textile marker application method and a secure textile product resulting therefrom While specific embodiments of the present invention have been described, it will be apparent to those skilled in the art that various modifications thereto can be made without departing from the spirit and scope of the invention. For example, while the present invention has been described using modifications to two known types of dyeing process, it may be carried out with appropriate modifications using any process that allows an application liquor to flow through a fibrous material. Accordingly, the foregoing description of the preferred embodiment of the invention and the best mode for practicing the invention are provided for the purpose of illustration only and not for the purpose of limitation.

1: A marked textile fiber assembly comprising an assembly of textile fibers including at least one identifiable marker disposed therein, the marker distributed substantially uniformly throughout the assembly.

2: The textile fiber assembly of claim 1 wherein the marker has an identifying property that is substantially indetectible in normal use.

3: The textile fiber assembly of claim 1 wherein the marker is nucleic acid based.

4: The textile fiber assembly of claim 1 wherein the amount of marker disposed in the textile fiber assembly is about 1 part per billion to about 10,000 parts per million.

5: The textile fiber assembly of claim 1 wherein the amount of marker disposed in the textile fiber assembly is about 1 part per billion to about 1000 parts per million need better upper limit.

6: The textile fiber assembly of claim 1 wherein the marker has an average size of about 1 nanometer to about 20 microns.

7: The textile fiber assembly of claim 1 wherein the marker has an average size of about 100 nanometers to about 5 microns.

8: A woven label comprising the textile fiber assembly of claim 1.

9: A garment comprising the textile fiber assembly of claim 1.

10: A document comprising the textile fiber assembly of claim 1.

11: A sewing thread comprising the textile fiber assembly of claim 1.

12: A product including the textile fiber assembly of claim 1 for identification purposes.

13: A method of producing a marked textile fiber assembly, comprising:
providing a textile fiber assembly and a package dye machine introducing the fiber assembly into the package dye machine; and
contacting the fiber assembly with a fluid including an identifiable marker under predetermined conditions such that the marker is distributed substantially uniformly throughout the assembly.

14: The method of claim 13 wherein the marker has an identifying property that is substantially indetectible in normal use.

15: The method of claim 13 wherein the fluid is water-based.

16: The method of claim 13, wherein the fluid further includes a chemical selected from the group consisting of silicone emulsions, mixtures of siloxanes and silicones, and mixtures thereof.

17: The method of claim 16 wherein the quantity of chemical applied is about 0.1% to about 30%, by weight of textile fiber.

18: The method of claim 16 wherein the quantity of chemical applied is about 0.25% to about 10%, by weight of textile fiber.

19: The method of claim 16 wherein the quantity of chemical applied is about 0.25% and about 8%, by weight of textile fiber.

20: The method of claim 13, wherein the fluid further contains a phosphate buffer.

21: The method of claim 13 wherein the marker is nucleic acid based.

22: The method of claim 13 wherein the amount of marker applied to the textile fiber assembly is about 1 part per billion to about 10,000 parts per million.

23: The method of claim 13 wherein the amount of marker applied to the textile fiber assembly is about 1 to about 1000 parts per million.

24: The method of claim 13 wherein the marker has an average size of about 1 nanometer to about 20 microns.

25: The method of claim 13 wherein the marker has an average size of about 100 nanometers to about 5 microns.

26: The method of claim 13 wherein the textile fiber assembly is sewing yarn.

27: The method of claim 13 further comprising incorporating the textile fiber assembly into a label for a garment.

28: The method of claim 13 further comprising incorporating the textile fiber assembly into a garment.

29: The method of claim 14 further comprising incorporating the textile fiber assembly into a document.

30: The method of claim 13 further comprising incorporating the textile fiber assembly into products for the purpose of identification.
